(19) United States
(12) Patent Application Publication
(10) Pub. No.: US 2009/0106982 A1
(43) Pub. Date: Apr. 30, 2009

(54) Knife holder

(76) Inventor: Robert Gerald Kushner, Mid-Levels (HK)

Correspondence Address: STUART WHITTINGTON, ESQ., 7037 E. MONTE CIRCLE, MESA, AZ, 85209, US

(21) Appl. No.: 11/977,321

(22) Filed: Oct. 24, 2007

(51) Int. Cl. B26B 3/00

(52) U.S. Cl. 30/142; 211/70.7

(57) ABSTRACT

A knife holder of one embodiment may include a knife-securing platform pivotally connected to a base portion. The platform includes a plurality of slots extending there through into which knifes may be inserted. The platform rotates about an axis of rotation with respect to the base and is substantially parallel with the plurality of slots extending through the platform. Other embodiments and variations are disclosed.

### BACKGROUND

Cutlery, such as a kitchen knife, is often times stored in a dedicated holder, for example made entirely of wood, which sits on a counter top. Such a storage unit is often referred to as a “block” which is descriptive of the overall monolithic block shape of a conventional knife storage unit. Openings shaped in the form of slots are typically formed in the top of the block and run vertically down into the block such that knives and/or scissors, etc. are inserted blade first into the block.

One issue associated with conventional knife blocks is that it is often difficult to know which knife is inserted into which slot. A user must individually remove each knife or utensil from the block until the desired knife is selected. This trial and error routine becomes frustrating and cumbersome.

Another issue with conventional knife blocks is that they are generally stationary in nature. Typically, the cutlery is inserted into a single solid unit of wood with a non-moving receiving surface. A user must reach for a particular knife or utensil from the block which can be difficult if there are several other knives in the path of the user's hand motion. Moreover, if the knives are compacted in the block or have the same general length and shape, the user may have difficulty grasping the butt of the knife to withdraw it from the block.

Yet another issue with conventional knife blocks is that they are notoriously bland, uneventful and generally unappealing as a countertop display.

### BRIEF DESCRIPTION OF THE SEVERAL VIEWS OF THE DRAWING

Aspects, features and advantages of the present invention will become apparent from the following description of the invention in reference to the appended drawing in which like numerals denote like elements and in which:

FIGS. 1-2 illustrate a knife holder according to a first embodiment of the present invention;

FIG. 3 illustrates a knife holder according to an embodiment of the present invention;

FIGS. 4-5 illustrate yet other exemplary embodiments of a knife holder according to the present invention;

FIG. 6 illustrates another embodiment of a knife holder of the present invention; and

FIG. 7 illustrates a further embodiment of the present invention.

### DETAILED DESCRIPTION OF THE INVENTION

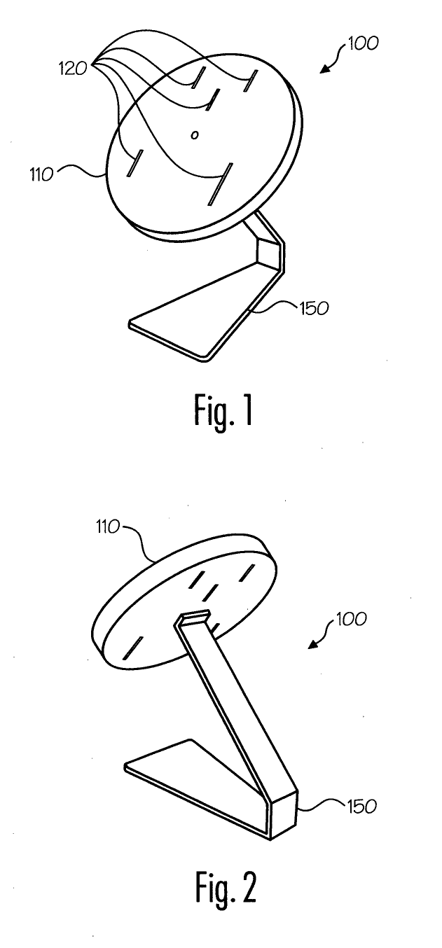

According to embodiments of the present invention, referring to FIG. 1, a knife holder 100 according to a first embodiment includes a knife-securing platform 110 and a base portion 150 attached to platform 110. The knife-securing platform 110 includes a plurality of slots 120 into which cutlery may be inserted in a manner similar to conventional cutlery blocks, i.e., blade or sharp end first. However, unlike conventional blocks, the inventive embodiments of the present invention include platform 110 that is pivotally attached to the base portion 150.

In some embodiments, platform 110 may rotate clockwise or counterclockwise about an axis of rotation which is substantially parallel to a longitudinal axis of one or more knives (not shown) inserted into, and held by, slots 120. The platform may be set in motion (rotating or the like) by manual or mechanical methods. For example, the user may gently spin the platform by hand or turning on a power button (not pictured) to start the platform moving using a suitable mechanical mechanism.

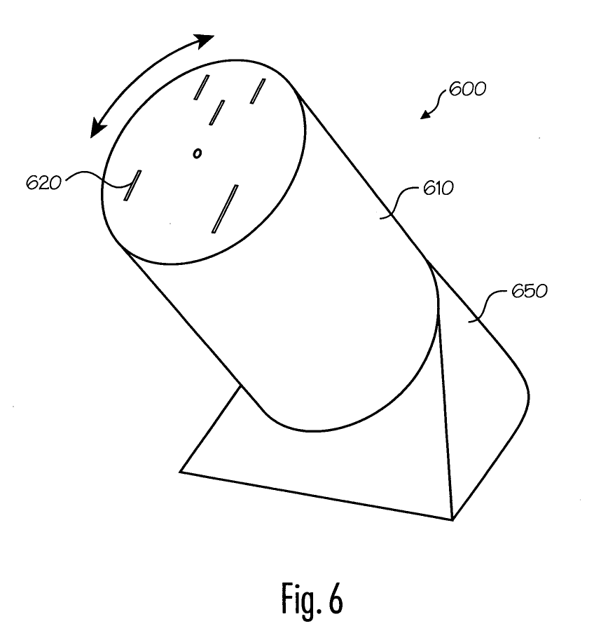

In the embodiments depicted in FIGS. 1-5, the knife-securing platform 110 may be disk-shaped (e.g. having a round, oval, trapezoidal or any shaped circumference) and of relatively shallow depth to allow a user to observe the length or type of blade associated with a knife handle appearing on a top surface of the platform 110. The disk type of arrangement facilitates rapid identification of individual utensils held in holder 100 without requiring labels or other identifying indicia, and without having to guess through trial and error which utensil is being selected. In other embodiments, the knife-securing platform and corresponding utensil slots may extend the full length of any blade or utensil inserted into the holder as shown best in the exemplary embodiment of FIG. 6. Further, the knife-securing platform may be constructed of a transparent material. In certain embodiments, platform 110 may include one or more magnets disposed near slots 120 to help secure knifes within the holder 100.

In various embodiments, platform 110 may be secured onto base 150 in a manner such that platform 110 may rotate about an axis. The axis of rotation of platform 110 is preferably parallel to the longitudinal axis of knifes or other utensils being held in slots 120 of platform 110. Furthermore, the axis of rotation may preferably be at an angled position between 10-80° with respect to a horizontal surface, such as a counter top, on which base 150 may be resting. In a most preferred embodiment, the angle between the axis of rotation and a counter surface would be approximately 45°. The angled nature of the rotating platform allows the holder 100 to be placed on a countertop beneath cabinets and to withdraw and store knifes using the simplest and most natural movement of a user's arm.

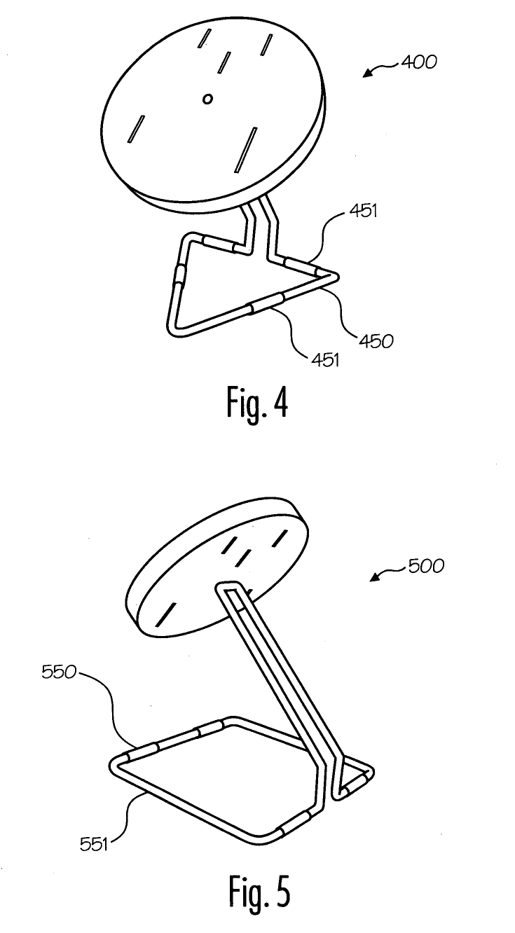

In the various embodiments, knife holder 100, or any portion thereof, may be formed from wood, particle board, poly-resins and/or molded plastics, metal or any combination of such suitable or other materials. In certain embodiments, platform 110 is formed of a hardwood such as oak or mahogany and base 150 is a constructed of metal, for example, a metal strip (e.g., FIGS. 1-2) or a metal wire stand (e.g., FIGS. 4-5). In other embodiments (e.g., FIG. 6), both the knife-securing rotating platform and the base are formed of the same material such as wood or the like.

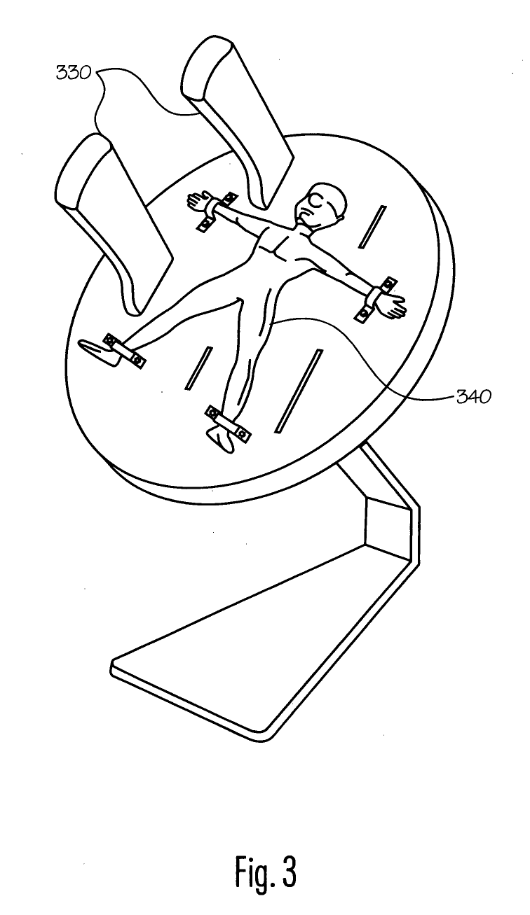

In optional embodiments, referring to FIG. 3, knife holder 100 may additionally include a weighted balance 340 to facilitate desired orientation of the rotating platform. In certain embodiments, balance 340 may be in the form of a human figurine which is included on the top surface of platform 110 and arranged with slots 120 such that knife holder 100, when holding knives 330, has the appearance of a human knife throwing wheel seen at a circus or carnivals and the like. This particular arrangement and construction can provide balance to the rotating platform as well as interest to the appearance of the knife block as a countertop display.

FIGS. 4 and 5 illustrate embodiments of respective holders 400, 500 having alternate base arrangements. For example FIG. 4 shows holder 400 having a metal wire base 450 to support the rotating knife-securing platform. In this embodiment, base 450 may have a triangle-shaped horizontal surface with one or more friction members 451 to prevent base 450 from inadvertent sliding on a horizontal surface, such as a countertop, upon which knife holder 400 may be resting. Friction members 451 may be rubber or plastic grommets or pads to prevent slippage and may also serve to prevent the wire base 450 from scratching a counter surface or the like.

The exemplary embodiment 500 of FIG. 5 includes a wire base 550 similar to that of FIG. 4 but having a rectangular or square-shaped horizontal surface. Base 550 may alternatively have a rounded or oval horizontal surface and may also include one or more friction members, if desired. As shown, the embodiments depicted in FIGS. 4 and 5, and the respective bases 450, 550 may also include an angled vertical portion which attaches to and facilitates rotating of the corresponding knife-securing platform.

FIG. 6 illustrates a knife holder 600 having an extended rotating knife-securing platform 610. Platform 610 may extend the full length of the blades/utility end of utensils, or longer, that are inserted into slots 620. Holder 600 has more of a traditional appearance but includes the rotating knife-securing platform 620. As with any embodiment herein, holder 600 may include a balancing weight similar to weight 340 shown in FIG. 3 or other balancing weight if desired. Additionally, platform 610, or any portion thereof, may be constructed of a transparent or translucent material so the contents secured by slots 620 are visible.

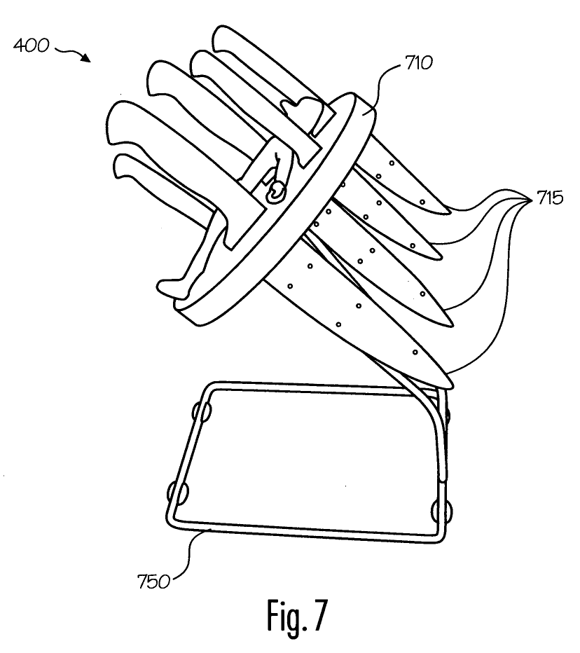

Referring to FIG. 7, an alternate knife holder 700 according to various may include the disc-shaped platform 710 and sheaths or sleeves 715 attached to corresponding platform slots. In this manner, injury due to rotation of platform 710 when securing knives, can be avoided. To enable a user to view the corresponding knife in a slot, although not required, the sleeves 715 may be formed of at least partially transparent or translucent plastic. Alternatively, a user can tell what blade is present in each slot by a length of the respective sleeve 715.

In various embodiments, the slots rotating in platform 710 and/or corresponding sleeves 715 may include one or more magnets to assist in securing stainless steels utensil blades when inserted therein. In this manner, a stainless steel knife inserted into holder 700 may be magnetically secured to prevent undesired movement when platform 710 rotates about its axis of rotation.

It should be recognized that the specific arrangements and configurations for various container supports with tool could vary greatly and the embodiments of the invention are not limited to any particular configuration or arrangement shown in the example embodiments.

Unless contrary to physical possibility, the inventor envisions the components of respective embodiments may be combined in any manner.

Although there have been described preferred embodiments of this novel invention, many variations and modifications are possible and the embodiments described herein are not limited by the specific disclosure above, but rather should be limited only by the scope of the appended claims.

What I claim is:

1. A utensil holder comprising:
a utensil securing platform having a plurality of slots disposed in a top surface of the platform, said slots extending at least partially through the platform and configured to allow insertion of one or more utensils; and
a base rotatively coupled to the platform to allow the platform to rotate about an axis of rotation with respect to the base, the axis of rotation being substantially parallel with the plurality of slots extending through the platform and in a range of between 10-80 degrees with a horizontal surface upon which the base would be resting.

2. The utensil holder of claim 1 wherein the platform is disk-shaped and the plurality of slots extend fully through the platform in a manner that a blade portion of the one or more utensils is viewable when inserted into one of the slots.

3. The utensil holder of claim 2 wherein the one or more utensils comprise knives, the utensil holder further comprising a plurality of sleeves coupled to a bottom side the platform to sheath the blade portion of the knives.

4. The utensil holder of claim 3 wherein the utensil holder includes the two or more pieces of cutlery.

5. The utensil holder of claim 1 further comprising a balance weight disposed on the top surface of the platform, the balance weight having a form of a human figure.

6. The utensil holder of claim 1 wherein the base comprises a metal wire base having a horizontal portion to rest on the horizontal surface and an angled vertical portion secured to the platform to allow the platform to rotate about the axis of rotation when utensils are inserted into the plurality of slots.

7. The utensil holder of claim 1 wherein the platform and the base are comprised of wood.

8. The utensil holder of claim 1 wherein the platform is cylindrical shaped and having a length which fully encompasses blade portions of the one or more utensils when inserted into the plurality of slots.

9. A knife set comprising:
a plurality of knives; and
a knife holder comprising a base portion and a knife-holding platform coupled to the base portion, wherein the platform includes a plurality of slots into which the knives may be inserted, the platform being coupled to the angled base portion via a pivot such that an axis of rotation of the platform is substantially parallel to one or more knives when inserted into the slots and in a range between 10-80 degrees with a horizontal surface upon which base portion will rest.

10. The knife set of claim 9 further comprising a balancing weight attached to a top surface of the platform, the balancing weight having a shape of a human figure.

11. The knife set of claim 9 wherein the base portion and the platform are comprised of wood.

12. The knife set of claim 9 wherein the base portion is formed of metal and the platform is formed of wood.

13. The knife set of claim 9 wherein the platform is formed in a disk shape and wherein the plurality of slots extend fully through the platform so at least a portion of a blade of the plurality of knives is viewable when inserted into the plurality of slots.

14. The knife set of claim 13 further comprising a plurality of sleeves attached to a bottom side of the platform, each sleeve corresponding to a respective slot to sheath the blade portion of each of the plurality of knives when inserted.

15. The knife set of claim 9 further comprising one or more magnets disposed proximate each of the plurality of slots to magnetically secure each knife inserted therein.

16. The knife set of claim 14 further comprising one or more magnets disposed in each sleeve to magnetically secure a knife inserted in the respective slot.

17. The knife set of claim 9 wherein the platform is cylindrical and fully covers a blade portion of each knife when inserted into one of the plurality of slots.

18. The knife set of claim 10 wherein the plurality of slots are arranged on the platform between one or more limbs of the balancing weight.
